(19) United States
(12) Patent Application Publication
(10) Pub. No.: US 2010/0240572 A1
(43) Pub. Date: Sep. 23, 2010

(54) SPRAY-BASED DEGREASING FLUID

(76) Inventors: Bernard K. Zysman, Amherst, NY (US); Gregory E. Robinson, Tonawanda, NY (US)

Correspondence Address: Vincent G. LoTempio, Suite 1002, 69 Delaware Avenue, Buffalo, NY, 14202, US

(21) Appl. No.: 12/725,113

(22) Filed: Mar. 16, 2010

Related U.S. Application Data
(60) Provisional application No. 61/161,863, filed on Mar. 20, 2009.

(51) Int. Cl. C11D 3/24

(52) U.S. Cl. 510/365

(57) ABSTRACT

Disclosed is a composition for degreasing surfaces comprising about 75 to about 99.9% by volume parachlorobenzotrifluoride and about 0.1 to about 25% by volume of an organic modifier selected from the group consisting of odorless mineral spirits, an alkane from C1 to C8, acetone, an alcohol from C1 to C8, benzene, xylene, toluene, Stoddard's solvent, t-butyl acetate, a glycol, isoparaffin, and dimethylene carbonate. Additionally, it relates to a degreasing fluid comprising parachlorobenzotrifluoride to be applied using a spray application.

This application claims priority of U.S. Provisional Patent Application of Gregory Robinson, Ser. No. 61/161,863 for SPRAY-BASED DEGREASING FLUID filed on Mar. 20, 2009.

### BACKGROUND OF THE INVENTION

1. Field of the invention

This patent application relates to a spray-based degreasing fluid containing an exempt volatile organic compound. In particular, it relates to a degreasing fluid comprising parachlorobenzotrifluoride applied using a spray application.

Many current grease and oil removers have increasingly been subject to legislative bans and consumer avoidance because these cleaners contain unsafe chemical entities. These chemicals are toxic, carcinogenic, and/or ozone depleters. Indeed, volatile organic compound (VOC) content is increasingly an issue in and throughout North America. As a result, an alternative degreasing agent that has low-toxicity, is non-carcinogenic and is not an ozone depleter is desired. One such alternative is parachlorobenzotrifluoride (PCBTF). This disclosure provides a cleaning composition that is a blend of PCBTF and odorless mineral spirits (OMS).

To alleviate flammability concerns, various additives have been proposed to elevate the flash point of the resultant mixture. U.S. Pat. No. 6,429,176 issued the Chen, et al. presents a blend of a benzotrifluoride with 1,1,2-trichloroethylene (TCE). However, TCE is a carcinogen, thus defeating the purpose of preparing an alternative degreasing agent. U.S. Pat. No. 5,756,002 issued to Chen et al. describes a blend of benzotrifluoride and a fluorocarbon, alkyl perfluoroethers, or fluorochlorocarbons. However, each of these classes of additives has been implicated in various adverse health and/or environmental effects. U.S. Pat. No. 6,020,299 issued to Chen, et al. discloses a single phase fluid comprising a chlorinated benzotrifluoride and a perfluorinated liquid. However, perfluorinated chemicals do not break down in the environment, and they accumulate in the body raising concern for potential environmental contamination and long-term health effects.

To date, PCBTF is used as a degreaser at high concentrations but only in wipe cleaning and dip cleaning applications. Wipe cleaning and dip cleaning applications may be suitable when degreasing large surfaces or where there is sufficient space to be able to wipe the surface with a rag. Particularly, in the automotive segment, dip cleaning is used before parts are installed on the automobile. Once the parts are installed, dipping is no longer feasible. One could wipe clean installed parts, but only if there is sufficient space to use a rag and as long as the surface to be wiped does not contain sensitive surface features or is easily damaged by applied pressure. Therefore, there is a need for a degreasing composition containing PCBTF which cleans surfaces without necessitating dipping or wiping of the soiled surface—namely a spray-based cleaning composition.

There may be spray applications that use PCBTF, but only in low concentrations. Methods using low concentrations of PCBFT are suitable for certain applications, but are infeasible in others; for example, in the automotive repair/service industry. Spray cleaners containing PCBTF have PCBTF concentrations usually between 10-15% by volume and often contain hazardous volatile organic compounds (VOCs) and/or hazardous air pollutants (HAPs). The relatively low percentage of PCBTF yields a cleaner with decreased degreasing efficiency resulting in the need to use greater amounts of the cleaners, subsequently releasing greater amounts of the hazardous materials in the mixtures. Thus, a spray-based application which reduces or eliminates adverse health and environmental impacts and contains a high percentage by volume of PCBTF is needed and is the subject of the present disclosure.

### SUMMARY OF THE INVENTION

We have discovered a cleaning composition made from a blend of PCBTF and OMS. Surprisingly, this composition cleans better than would be expected. Namely, the blend of PCBTF and OMS cleans better, while also cleaning more surfaces, then either the PCBTF alone or the OMS alone. Moreover, delivery of a cleaning composition comprising PCBTF and OMS via a pump or trigger air assisted spray application provides additional unexpected results. That is, the pump or trigger air assisted spray delivery application alleviates flammability concerns when using PCBTF, particularly when compared to aerosol delivery. Specifically, after the composition is applied to a surface and exposed to a flame, the pump or trigger spray application of the composition unexpectedly does not readily combust while the aerosol application of the composition does combust when exposed to the flame.

### DESCRIPTION OF SPECIFIC EMBODIMENTS

A preferred embodiment of the present disclosure is a degreasing fluid comprising a blend of about 75 to about 99% by volume PCBTF and about 1 to about 25% by volume OMS. Preferably the composition contains about 90 to about 99% PCBTF and about 1 to about 10% OMS. It is envisioned that additional organic modifiers other that OMS may be used to blend with PCBTF; for example, an alkane (straight chain, branched, or cyclic) from C1-C8, a glycol, acetone, alcohols (methanol, ethanol, isopropyl alcohol, etc.), benzene, xylene, toluene, isoparaffin, mineral spirits, dimethylene carbonate, or t-butyl acetate. PCBTF is VOC exempt as stipulated in 40 CFR 51.100 and evaporates quickly, has low toxicity, is non-carcinogenic, is not an ozone depleter, and is rated nonflammable by the United States Department of Transportation.

Although a general purpose degreaser, the above composition is developed to specifically target automotive applications, particularly cleaning and degreasing automotive brakes parts. However, experimental use of this embodiment unexpectedly showed that this composition is suitable to a wider range of automotive cleaning applications, including mass airflow sensors and hydraulic oil. Mass airflow sensors possess a number of sensors which monitor the fuel/air mixture supplied to an engine. Traditional cleaners require wiping which either leaves behind a residue or otherwise damages the sensor rendering it nonfunctional. Alternative cleaners suffer the health and/or environmental drawbacks described earlier or are composed of solvents which are too harsh to use on the delicate sensor surfaces. Surprisingly, the present disclosure is able to clean the mass airflow sensor surface without damaging the various sensor surfaces, while also evaporating quickly without leaving a residue behind. Additionally, construction vehicles use hydraulic oil to manipulate the various control arms, lifts, buckets, etc. used by the vehicle to perform its work. The hydraulic oil leaks or is otherwise forced out of joints between connections on the vehicle. It is important to remove this oil to ensure proper functioning of the various operating moieties. However, traditional cleaners are unable to efficiently remove the hydraulic oil. For unknown reasons, the PCBTF and OMS blend is able to cut through the hydraulic fluid for easy cleaning of the vehicle.

The composition of a blend of PCBTF and OMS of a preferred embodiment of the present disclosure further unexpectedly cleans other soiling agents better than either components of the blend individually. A field study was conducted to more fully determine the range of cleaning effectiveness of the composition blend of PCBTF and OMS of a preferred embodiment. PCBTF was applied to the soiled substrate and the surface was wiped. Visual inspection of the substrate found that only about three-quarters of the soiling agents were removed by the PCBTF. The above protocol was reproduced replacing PCBTF with OMS. Visual inspection of the substrate using OMS as the cleaning agent resulted in only about two-thirds removal of the soiling agents. Lastly, a blend of PCBTF and OMS according to a preferred embodiment of the present invention was applied and wiped visually yielding complete cleaning of the substrate.

In an additional embodiment, the composition can also contain, as an additional component, one or more odor masking agents having a concentration of about 0.1 to about 0.5% by volume. Any fragrance may be used as an odor masking agent, however, in a preferred embodiment this masking agent possesses a similar evaporation rate as PCBTF and does not leave a residue on the cleaned surface following evaporation. Examples of suitable odor masking agents include but are not limited to Cherry Mask #5236, commercially available from Andrea Aromatic, Princeton, N.J., Cherry Almond 183-301 and Citrus 173-218, available from Alpine Aromatics International, Inc. (Piscataway, N.J.), #18293 and #18294 available from Atlanta Fragrance (Kennesaw, Ga.), and Fruity Vanilla 83576 and Fruity 91754 available from Stanley S. Schoenmann, Inc. (Clark, N.J.).

The blended composition of PCBTF and OMS, which optionally further comprises at least one odor masking agent, is to be applied by a spray application of a preferred embodiment of the present disclosure. Although the degreasing formulation can be aerosolized in a spray can utilizing an inert gas, such as carbon dioxide, nitrogen, air, or the like as the propellant, this delivery method has the drawback of combusting when exposed to a flame after being applied to a substrate. In a preferred embodiment, the degreasing fluid is stored in a non-pressurized container. This container can be of any size, ranging from a small bottle such as one commonly used for household cleaners to a large 55 gallon drum or larger container. No matter the size of the container, a pump or trigger spray mechanism is used to draw the fluid to an atomizer from which the fluid is then dispersed in fine droplets onto a soiled surface. The pump or trigger spray application has an unexpected advantage in that the resultant applied composition does not readily combust when exposed to a flame. Additional embodiments of the present disclosure include pneumatic sprayers and high volume low pressure sprayers wherein the spray vessel is charged with degreasing fluid and then pressurized using an air compressor.

Optimally, the degreasing fluid is sprayed in a narrow cone with sufficient pressure to penetrate the grease without damaging the underlying surface. Spray optimization is a function of the type and thickness of the grease deposited on the surface and the type of material comprising the surface. The pressure and overall coverage of the sprayed fluid is variable and controllable by adjusting the distance between the greased surface and the spray nozzle as the fluid is applied. The closer the nozzle to the surface, the greater the pressure but narrower the cone of applied fluid.

Although the disclosure has been described with reference to certain preferred embodiments, it will be appreciated by those skilled in the art that modifications and variations may be made without departing from the spirit and scope of the disclosure. It should be understood that applicant does not intend to be limited to the particular details described above.

What is claimed is:

1. A composition comprising:
(a) about 75 to about 99.9% by volume parachlorobenzotrifluoride; and
(b) about 0.1 to about 25% by volume an organic modifier selected from the group consisting of odorless mineral spirits, an alkane from C1 to C8, acetone, an alcohol from C1 to C8, benzene, xylene, toluene, Stoddard's solvent, t-butyl acetate, a glycol, isoparaffin, and dimethylene carbonate.

2. The composition of claim 1 wherein said composition further comprises at least one odor masking agent having a concentration from about 0.1 to about 0.5% by volume.

3. The composition of claim 1 wherein said organic modifier is odorless mineral spirits.

4. The composition of claim 1 wherein said organic modifier is t-butyl acetate.

5. The composition of claim 1 wherein said organic modifier is isoparaffin.

6. The composition of claim 1 wherein said organic modifier is dimethylene carbonate.

7. The composition of claim 1 wherein said organic modifier is a glycol.

8. The composition of claim 1 wherein said organic modifier is acetone.

9. The composition of claim 1 wherein said organic modifier is Stoddard's solvent.

10. The composition of claim 1 wherein said organic modifier is acetone.

11. A composition comprising:
(a) about 90 to about 99.9% by volume parachlorobenzotrifluoride; and
(b) about 0.1 to about 10% by volume odorless mineral spirits.

12. The composition of claim 11 wherein said composition further comprises at least one odor masking agent having a concentration from about 0.1 to about 0.5% by volume.

13. A method for degreasing a surface comprising:
(a) providing a composition comprised of about 75 to about 99.9% by volume parachlorobenzotrifluoride and about 0.1 to about 25% by volume an organic modifier selected from the group consisting of odorless mineral spirits, an alkane from C1 to C8, acetone, an alcohol from C1 to C8, benzene, xylene, toluene, Stoddard's solvent, t-butyl acetate, a glycol, isoparaffin, and dimethylene carbonate; and
(b) providing a means for air assisted pressurized spraying of said composition.

14. The method of claim 13 wherein said organic modifier is odorless mineral spirits.

15. The method of claim 13 wherein said means for air assisted pressurized spraying is a trigger sprayer, aerosol, pump spray, high pressure/low volume, pneumatic.

16. The method of claim 13 wherein said means for air assisted pressurized spraying is a pump sprayer.

17. The method of claim 13 wherein said means for air assisted pressurized spraying is an aerosol.

18. The method of claim 13 wherein said means for air assisted pressurized spraying is a pneumatic sprayer.

19. The method of claim 13 wherein said means for air assisted pressurized spraying is a high pressure/low volume sprayer.

20. The method of claim 13 wherein said composition further comprises at least one odor masking agent having a concentration from about 0.1 to about 0.5% by volume.
